(19) United States
(12) Patent Application Publication
(10) Pub. No.: US 2005/0210278 A1
(43) Pub. Date: Sep. 22, 2005

(54) Mass storage apparatus for securely delivering digital content to a host computer and method for using same

(76) Inventors: Bruce Conklin, San Antonio, TX (US); Suzan Conklin, San Antonio, TX (US); Wes Conklin, San Antonio, TX (US); Patricia Godkin, Pipe Creek, TX (US)

Correspondence Address: JACKSON WALKER L.L.P., Suite 2100, 112 E. Pecan Street, San Antonio, TX, 78205, US

(21) Appl. No.: 10/914,322

(22) Filed: Aug. 9, 2004

Related U.S. Application Data
(60) Provisional application No. 60/553,764, filed on Mar. 17, 2004.

(51) Int. Cl. H04K 1/00

(52) U.S. Cl. 713/194

(57) ABSTRACT

A mass storage apparatus, and method for using same, for securely delivering digital content to a host computer that satisfies the need for reliable, secure, and safe distribute distribution that is easy for end-users to use and for manufacturers to implement yet provides surpassing protection of Manufacturers' intellectual property. The apparatus provides both passive and active protection for the digital content to be distributed. Passive protection is designed to prevent physical access to the media within the apparatus. Active protection will render the media unreadable should the passive protection fail.

This patent application claims priority from Provisional Application No. 60/553,764 filed Mar. 17, 2004.

### FIELD OF THE INVENTION

Applicants' invention relates to a method and apparatus for the secure delivery of digital content. More particularly, Applicants' invention relates to a method and apparatus for securely delivering digital content which significantly reduces the risk of piracy and thereby protects the rights of intellectual property owners.

### BACKGROUND

Software is the backbone of the Information Age, and as such software is a very valuable component of both business and personal applications of technology. Software piracy exists in both of these sectors—from individual computer users to professionals who regularly sell unauthorized copies of stolen software, piracy exists in homes, schools, businesses, and government. Piracy has grown more prevalent as the demand for software has increased. Piracy has been driven by the widespread use of personal computers (PCs), increasingly sophisticated users, and their use of the Internet to distribute stolen software illegally.

After several years of decline, piracy rates have increased in recent years. According to the Business Software Alliance, despite continuing declines in software prices, global dollar losses due to software piracy increased 19% in 2002 to $13.08 billion.

There are multiple methods for stealing and illegally distributing copies of software. End-users may purchase a copy of a Manufacturer's licensed software and, after installing it on a computer, share it with someone else for illegal use on another computer. As the disks (i.e., diskettes, CD-ROMs, DVD-ROMs) that are typically used by the Manufacturer to distribute the software can be easily copied and distributed, this type of illegal sharing has the potential for a domino effect, moving the software from one illegal use to another. Many software pirates (a.k.a., crackers) view the act of piracy as a game, and enjoy the prestige of having “cracked” any existing protection scheme to obtain an illegal copy of the software.

Another common act of piracy involves taking advantage of software upgrade offers without having a legal copy of the version of the software that is being upgraded. Non-retail software, such as that used in academic applications, or business specific software, may also be acquired for illegal use without permission of the author or owner to do so.

Internet piracy has also become a pervasive means of illegally obtaining and distributing software. Prior to the advent of the Internet, unauthorized copying and sharing of software required the physical exchange of floppy disks, CD-ROMs, or other hard media. With the advent of the Internet, software piracy is easier, faster and less expensive. In the United State alone, nearly 100 million Americans have access to the Internet; supplying software pirates with a ready market for illegal software.

Internet piracy includes the use of “private websites” that make illegal copies of software available for free or in exchange for copies of other software. Internet auction sites also offer counterfeit copies for unauthorized sale.

Software counterfeiting has grown to include the illegal duplication and sale of copyrighted material with the intent of imitating its functionality and typically includes the packaging, manuals, license agreements, labels, registration cards, and security features. Peer to peer networks also provide for rapid, inexpensive transfers of stolen copyrighted programs.

Currently, software manufacturers develop and package application software for distribution to the end user. The most common means of current distribution is to load the software to a CD-ROM disk. The stand-alone nature and capacity of the disk limits the sophistication of available measures that can be used to protect the application software from acts of piracy. The current capacity for a CD-ROM disk is approximately 700 MB raw, though a CD-ROM software load can be compressed to allow extended capacity. Once loaded to the CD-ROM, no changes can be made to the application software.

Software is then distributed in accordance with the Manufacturer's license and use agreement which prohibits unauthorized copying and/or distribution by the licensee. Manufacturers' application software is protected from unauthorized access, and subsequent unauthorized distribution, through multiple algorithm driven processes that are designed to ensure use by the licensee only on a limited number of computers (typically one or two).

For example, one of the protective processes employed by Microsoft Corporation, perhaps the largest provider of software in the world, uses algorithms to create a serial number using a combination of the end user's name. Microsoft's process captures a CPU serial number and information regarding a second piece of hardware, typically the Ethernet card, to generate another code. The registration process for Microsoft's software then transmits that code to Microsoft and records the installation of that software onto a particular computer.

In general an end-user is given several options for registering software. The user usually may opt to use the software for a trial period without registering the software. Software manufacturers often designate how many times, or for how long, the software can be accessed without registration. At the end of such time, the software is disabled if the user fails to register. This process can be defeated through the use of ripping (a process of defeating software encryption) or key generators which provide illegally obtained registration keys.

An alternative method of registration allows the user to complete a registration form and submit the form via fax. In yet another alternative, the user can access the Manufacturer through the Internet and register the software.

If the end-user has a valid code, the software is released and available for use on the end-user's computer and the end-user is able to access the software; the software installation process is completed.

The software distribution process as described above has several weaknesses which may be attacked by individuals bent on accessing the software for unauthorized purposes.

A first weakness of current software distribution methods is inherent in the medium of distribution. Diskettes, CD-ROMs, or DVD-ROMs are susceptible to acts of piracy and can be copied in their entirety or can be separated from any encryption software (or other security protection) simply by copying the application software to a PC's hard drive and overriding the protection. Overriding the protection can be accomplished by using any of the following alone or in combination: a ripping program to override any encryption protection; a small program (or patch) to bypass the protection encryption program; an ISO image of the entire contents of the CD-ROM and loading the contents to a PC's hard drive in order to override the use of any protection embedded on the CD-ROM. Once the protection on the installation media is breached, the application software can be easily shared with others and installed on multiple computers for unlimited unauthorized use.

Another weakness is that crackers can freely obtain a required key code to unlock the encryption. Key codes are readily available on Internet web sites and Internet cafes that support software piracy or by simply visiting a software retail outlet to illegally obtain the manufacture's key codes that will unlock any currently used product activation algorithms.

Yet another weakness of the current software distribution systems is that all installations currently use standard program files and common file names. These installation files are routed to installation and system folders and reside on the host computer. Crackers can search for all the necessary files to run the program to produce a copy and use the disk to bootleg software.

Software manufacturers and distributors (“Manufacturers”) have a requirement for packaging and shipping their proprietary application software products so that there is adequate protection from any attempt to obtain and use the software except as intended by the manufacturer's license agreement. This includes the prevention of access to the software for unauthorized distribution and use in violation of the Manufacturer's license and use agreement. Despite the efforts of Manufacturers to control piracy with product activation that requires key codes obtained from the Manufacturers, as well as other protection methods, piracy of software continues to be a world-wide problem for software distribution, costing billions of dollars in lost sales revenue each year.

Any party that desires to distribute or deliver proprietary information, including software, requires secure, cost effective protection for the intellectual capital to ensure that it is transferred, sold, or distributed in a manner that is in keeping with the originator's intended use only, as stated in the license or use agreement, and with protection methods that are commensurate with the intellectual property's value. This need for protection applies to any proprietary information, both government-related and in the private sector, including such examples as proprietary computer software, new movie screenings, or captured ballots at voting polls; whether for distributing such software or information, capturing it for transfer to a master file, or for simply storing such software or information in a safe manner until needed.

Therefore, a need exists to reliably, securely, and safely distribute digital content that is easy for end-users to use and for Manufacturers to implement yet provides surpassing protection of Manufacturers' intellectual property. Applicants' invention satisfies this need by providing a secure means to distribute digital content with all the advantages of the prior art but with none of the prior art's inherent weaknesses.

### SUMMARY

The present invention is directed to a mass storage apparatus for securely delivering digital content to a host computer that satisfies the need to reliably, securely, and safely distribute digital content that is easy for end-users to use and for manufacturers to implement yet provides surpassing protection of Manufacturers' intellectual property. A mass storage apparatus having features of the present invention is a peripheral in communication with a host computer and comprises a media member, a sealed housing enclosing the media member, a two-way communications means, an energy supply, and a software driver to facilitate communication between the apparatus and a host computer. The housing is adapted to prevent physical access to the enclosed media member and may be further adapted to render the media member unusable if an attempt is made to open the sealed housing. The software driver is adapted to provide two-way communications between the apparatus and the host computer while simultaneously preventing unauthorized electronic access to the protected intellectual property.

The media member stores the software or other digital content for which protection is desired. The media may be a magnetic disk, an optical disk, a non-volatile solid-state memory device, or any other device adaptable to the storage of digital information and electronically accessible by a computer program.

Two-way communications between the mass storage apparatus and the host computer may be hard-wired and accomplished via a serial (RS-232) device, a bi-direction parallel (e.g., ECP, EPP) device, a universal serial bus (USB), a FireWire (IEEE 1394) device, a small computer systems interface (SCSI), an Integrated Drive Electronics (IDE) interface, or any other means of communication between a host computer and a peripheral device now known in the art or hereafter developed. Two-way communications between the mass storage apparatus and the host computer may also be wireless and accomplished via an industry standard radio frequency device such as Bluetooth, a proprietary radio frequency device, or an infrared radiation device (e.g., an IrDA compliant device).

A mass storage apparatus having features of the present invention provides multiple levels of protection for the software or other digital content recorded on the apparatus. In one embodiment, a first level of protection is physical and prevents access to the physical media on which the software or other digital content is recorded. A second level of protection is effected by software which prevents unauthorized electronic access to the mass storage apparatus while the apparatus is in electronic communication with the host computer. A third level of protection is effected by the encryption of the software or other digital content that is stored within the apparatus.

Physical protection in the present invention is both passive and active. Passive protection encompasses measures to prevent physical access to the media member within the mass storage apparatus. Such measures may include one-way screws, rivets, spot welds, epoxy, or other fastener to permanently seal the housing enclosing the media member. Active protection encompasses measures to render the media member unreadable should the passive protection of the mass storage apparatus be defeated.

In one embodiment, a method to render the media member unreadable is to disburse corrosive liquid over the surface of the media member. The corrosive liquid may be contained in a small closed vessel adapted to hold liquids. The vessel is preferably constructed of glass or other material which is easily broken with slight pressure. The vessel is placed in an appropriate location within the mass storage apparatus such that, upon breakage of the vessel, the corrosive contents are distributed over the surface of the media member. More than one vessel may be necessary depending upon the number of media members present within the mass storage apparatus. The vessel is broken in response to a breach of the cover of the mass storage apparatus. One method of breaking the vessel is via a loaded leaf spring held in place by a linchpin or other securing mechanism. When a breach of the sealed housing occurs, the linchpin is removed causing the leaf spring to impact and break the vessel. Another method of breaking the vessel is to place the vessel between two teeth within the mass storage apparatus. When the cover of the apparatus is removed, the teeth come together causing the vessel to break. Still other methods of breaking the vessel are contemplated. In the preferred embodiment, the distribution of the corrosive liquid is aided by physical means within the mass storage apparatus such as a spring-loaded arm which sweeps the corrosive liquid over the surface of the media member.

In another embodiment, a method to render the media member unreadable is to pass a magnet over the surface of the media member to scramble the electronic information stored thereon. Magnets are placed strategically within the mass storage apparatus such that, in regular operation, the magnetic fields of the magnets do not interfere with the proper operation of the apparatus yet are properly aligned to sweep along the surface of the media member when the sealed housing is breached. The magnets may also be shielded to prevent accidental erasure of information recorded on the media member during normal operation. The magnets are mounted on spring loaded arms or other structure which, when the sealed housing is breached, causes the magnets to sweep over the surface of the media member. The magnetic field of the magnets scrambles the electronic information stored on the media member thereby rendering the media member unreadable.

In another embodiment, a method to render the media member unreadable is to generate a sufficiently large magnetic field to scramble the electronic information stored on the media member. The magnetic field is generated by an electromagnet positioned near the media member. The electromagnet is composed of a battery or other source of electric current, a rod, preferably made of iron, and a segment of wire, preferably copper, coiled around the rod. One end of the wire is connectable to the positive end of the battery, the other end of the wire is connectable to the negative end of the battery to form a circuit which, while the apparatus remains sealed, is in the open state. The circuit is closed, thereby creating the electromagnetic field, when the sealed housing of the apparatus is breached. In one embodiment of this method, a pull-pin is included within the circuit. The pull-pin is held open by a non-conductive tab which is attached to the sealed housing cover. When the sealed housing cover is removed, the tab is also removed and the circuit is closed, thereby creating the electromagnetic field.

In another embodiment, a method to render the media member unreadable is to pass an electric current through the media member thereby scrambling the electronic information stored thereon. This method of rendering the media member unreadable comprises a battery or other source of electric current, a conducting wire connectable to the positive end of the battery, and a conducting wire connectable to the negative end of the battery. When the sealed housing is breached, two wires are brought into contact with the media member thereby completing a circuit and permitting an electrical current to pass through the media member.

In another embodiment, a method to render the media member unreadable is to physically damage or break the media member when an attempt is made to breach the sealed housing. One method of physically damaging or breaking the media is via a loaded leaf spring held in place by a linchpin or some other mechanism. When a breach of the sealed housing occurs, the linchpin is removed causing the leaf spring to impact and break the media member. Another method of breaking the media member is to place the media member between teeth within the mass storage apparatus. The teeth are mounted on the sealed housing cover and the sealed housing base such that when the cover is removed, the teeth come together causing the media member to break.

In another embodiment, a method to render the media member unreadable is to expose the media member to extremely high temperatures when the sealed housing is breached. In this embodiment, a circuit is held open by a tab, which is connected to the enclosure cover. When the cover of the hard drive enclosure is removed, the tab will also be removed and allow the circuit to close, activating high temperature generation through a battery powered heat coil located adjacent to the media member.

Also in accordance with the present disclosure, the present invention is directed to a method for securely delivering digital content using a secure mass storage apparatus is disclosed. A manufacturer stores software or other digital content onto the mass storage apparatus in encrypted form. The mass storage apparatus is then provided to the user who connects the apparatus to the user's computer via a two-way communications device (e.g., USB, IEEE 1394, Bluetooth, etc.). An installation program is run which installs the stored digital content or an access program to access the digital content onto the user's computer. The user's computer's serial number is then stored on the mass storage apparatus.

The installation program for the stored digital content or access program may reside either on the mass storage apparatus or on separate media. If stored on the mass storage apparatus, the installation program will be automatically invoked when the mass storage apparatus is connected to the user's computer. If stored on separate media, the installation program must be invoked separately by the user after the mass storage apparatus is connected to the user's computer.

The installation program may install the software, digital content, or access program in a masked location on the user's computer. The masking of installation location is accomplished through the use of generic or randomly created directory and file names such that the nature of the installed program is not derivable simply by reviewing the contents of the directory. The masked location is determined by an algorithm and may be determined by any combination of time of day, date, the physical contents of the user's computer (e.g., video adapter, network card, etc.), the software already installed on the user's computer, the peripherals attached to the user's computer and any other information ascertainable at the time of installation that would aid in the creation of a random directory name.

While the access program is in operation to view the digital content which remains resident on the mass storage apparatus, it may be desirable to prevent communication to and from the user's computer. In one embodiment, the access program will disable all network, modem, and internet connections while the access program is in operation. In another embodiment, the access program will disable access to “floppy disk” drives, CD-RW drives, DVD-RW drives, solid state memory devices, and the like while the access program is in operation.

In one embodiment of the current disclosure the installation program will maintain a counter to keep track of the number of successful installations completed. This counter will be stored on the mass storage apparatus and may be used to limit the number of times the software or other digital content may be installed onto a user's computer or computers.

### BRIEF DESCRIPTION OF THE DRAWINGS

These and other features, aspects, and advantages of the present invention will become better understood with regard to the following description, appended claims, accompanying drawings where:

FIG. 1 shows a perspective view of one embodiment of the current invention.

FIG. 1A shows a perspective view of one embodiment of the current invention.

FIG. 2 shows an exploded view of one embodiment of the current invention.

FIG. 3 shows an exploded view of the media device of one embodiment of the current invention.

FIG. 4 shows a sectional view of one method of physically preventing access to the media member of the current invention.

FIG. 5 shows a perspective view of one embodiment of active physical protection of the media member of the current invention.

FIG. 6 shows a perspective view of one embodiment of active physical protection of the media member of the current invention.

FIG. 7 shows a perspective view of one embodiment of active physical protection of the media member of the current invention.

FIG. 8 shows a perspective view of one embodiment of active physical protection of the media member of the current invention.

FIGS. 9 and 10 show a section view of one embodiment of active physical protection of the media member of the current invention.

FIG. 11 is a flow diagram representing the one embodiment the current invention.

### DESCRIPTION

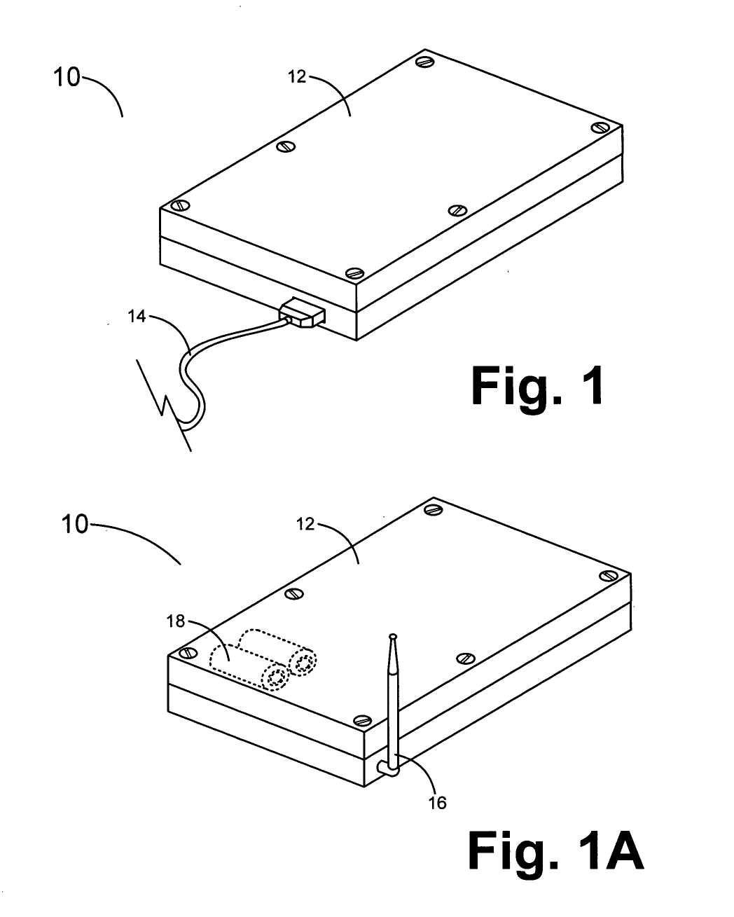

Referring to the figures, FIG. 1 illustrates one embodiment of Applicants' mass storage apparatus (10). In this embodiment, the mass storage apparatus (10) is an external device enclosed in a protective external housing (12) composed of metal or plastic. The mass storage apparatus (10) communicates with and draws electric power from a host computer (not shown) via a two-way communications and power supply cable (14). Communications over said two-way communications and power cable (14) may be accomplished via a serial device, a bi-direction parallel device, a universal serial bus, a FireWire device, a small computer systems interface, an Integrated Drive Electronics interface, or similar communications standard.

Referring now to FIG. 1A, communications between the mass storage apparatus (10) and the host computer (not shown) may also be accomplished wirelessly through a wireless adapter (16). To facilitate complete wireless connectivity between the mass storage apparatus (10) and the host computer (not shown), power to the mass storage apparatus (10) may be drawn from an enclosed battery pack (18).

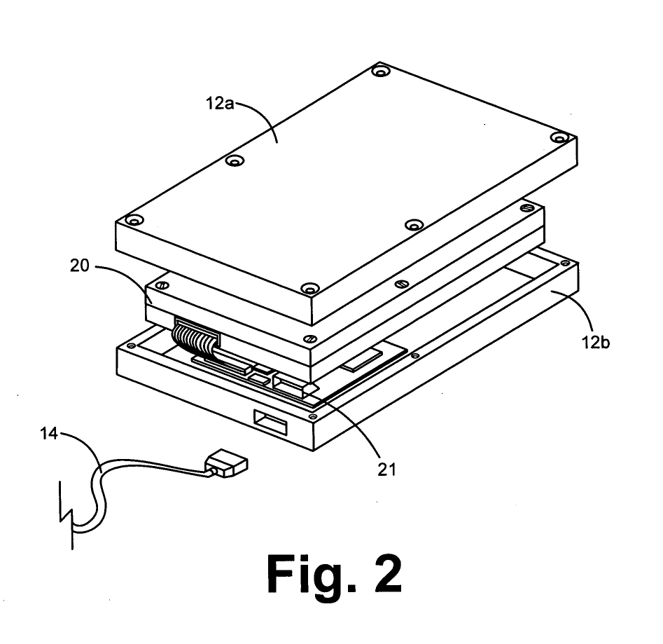

FIG. 2 is an exploded view of the mass storage apparatus (10). The media device (20) is enclosed between the external housing cover (12a) and the external housing base (12b). The two-way communications/power cable (14) is shown in a detached configuration. The communications interface port (21) receives two-way communications/power cable (14) to facilitate communication between the host computer (not shown) and the mass storage apparatus (10).

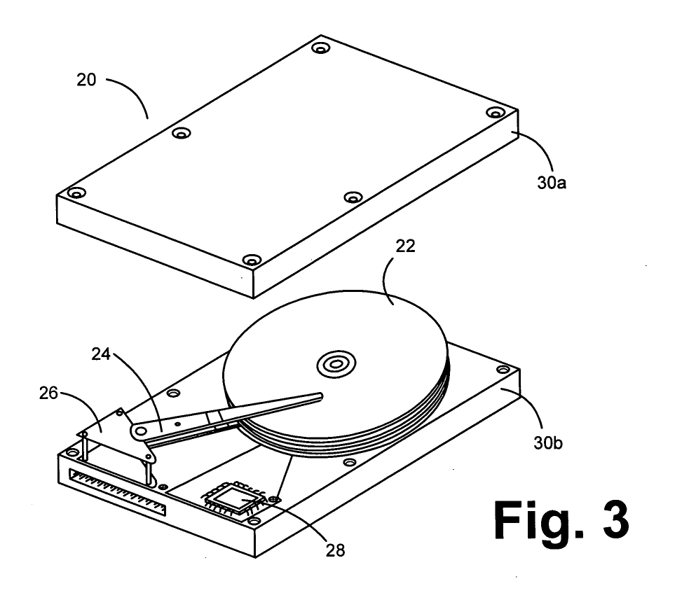

FIG. 3 shows an exploded view of the media device (20). Digital content is recorded onto the media member (22). The media member (22) may be magnetic, optical, or solid state. In the magnetic configuration, information is written to and read from the media member (22) via the read/write member (24). The read/write member (24) is supported by the read/write member support (26). The circuit board (28) facilitates communication between the mass storage apparatus (10) and the media device (20). The sealed housing cover (30a) and the sealed housing base (30b) protect the media member from unauthorized physical access and environmental hazards.

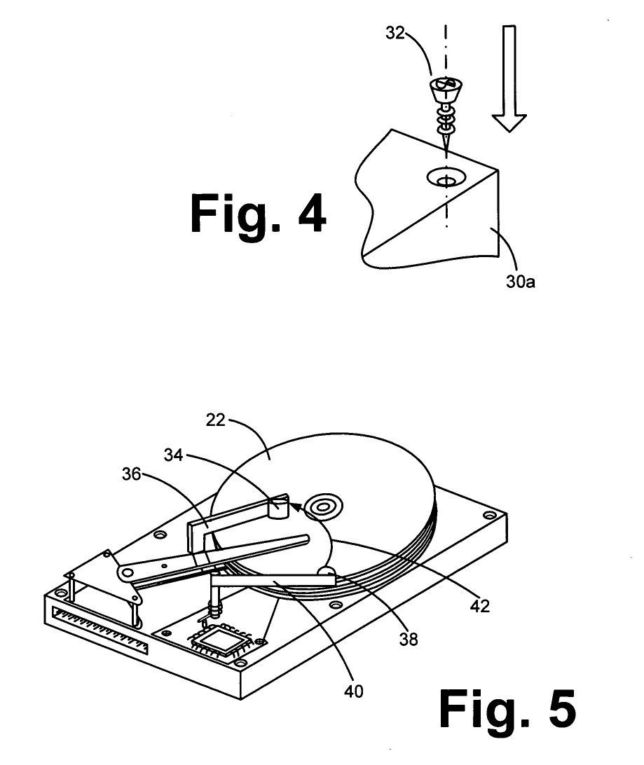

In alternate embodiments of the mass storage apparatus (10), passive measures maybe taken to prevent physical access to the media member (22) by permanently affixing the sealed housing cover (30a) to the sealed housing base (30b). FIG. 4 illustrates one example of such measures. A one-way screw (32) is shown which secures the sealed housing cover (30a) to the sealed housing base (30b) and prevents physical access to the media member (22). Other means of permanently affixing the sealed housing cover (30a) to the sealed housing base (30b) include rivets, spot welds, and epoxy.

Referring now to FIG. 5 which illustrates one embodiment of active physical protection of the content of the mass storage apparatus (10). Active protection encompasses measures to render the media member (22) unreadable should the passive protections (e.g., one-way screw [32]) be defeated. In one embodiment of active protection, a vessel (34), constructed of glass, plastic, or some other easily breached material, is adapted to contain a liquid and is mounted at the distal end of the vessel support arm (36). The vessel (34) is positioned adjacent to the media member (22) such that when the integrity of the vessel (34) is compromised, the contents of the vessel (34) will be distributed over the surface of the media member (22). The strike arm head (38) is mounted on the distal end of the spring-loaded strike arm (40) such that the vessel (34) is within arc of motion (42) of the strike arm head (38). When the sealed housing cover (30a) is removed, the spring-loaded strike arm (40) is released causing the strike arm head (38) to impact with and crush the vessel (34) thereby releasing the corrosive contents of the vessel (34) onto the media member (22) and rendering the media member (22) unreadable. In embodiments of the mass storage apparatus (10) comprising more than one media member (22), multiple vessels and strike arms may be positioned such that each media member is rendered unreadable.

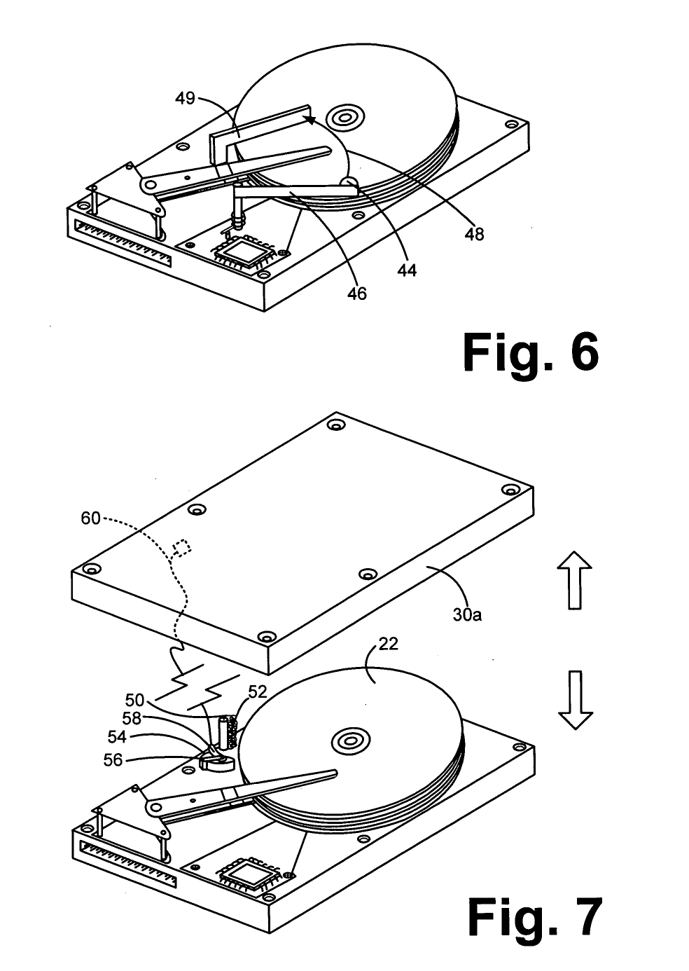

FIG. 6 illustrates an alternate embodiment of active physical protection of the content of the mass storage apparatus (10). In this embodiment, a magnet (44) is supported on the distal end of a spring-loaded support arm (46). The magnet (44) is shielded such that it does not interfere with the normal operation of the mass storage apparatus (10) prior to deployment. When the sealed housing cover (30a) is removed, the spring-loaded support arm (46) is released causing the magnet (44) to travel in an arc (48) over the surface of the media member (22) thereby magnetically erasing portions of the information stored thereon. The movement of the support arm (46) is terminated by the stop member (49). In embodiments of the mass storage apparatus (10) comprising more than one media member (22), multiple magnets may be supported by multiple support arms such that each media member is affected when the sealed housing cover (30a) is removed.

Referring now to FIG. 7 which illustrates one embodiment of active physical protection of the content of the mass storage apparatus (10). In this embodiment, an electromagnet is formed by a wire (50) is coiled about an iron rod (52). A first end of the wire (50) is connected to a battery contact for the negative terminal of the battery (54). A second end of the wire (50) is connected to a battery contact (56) for the positive terminal of the battery (54). The circuit is kept open by a battery tab (58) which is disposed between the positive terminal of the battery (54) and the battery contact (56). The battery tab (58) is connected to the sealed housing cover (30a) via the battery tab line (60) such that upon removal of the sealed housing cover (30a), the battery tab (58) is removed allowing the battery contact (56) to come into contact with the positive terminal of the battery (54) thereby closing the circuit. With the circuit closed, the electromagnet is energized generating a magnetic field which causes significant portions of the magnetically stored data on the media member (22) to be erased.

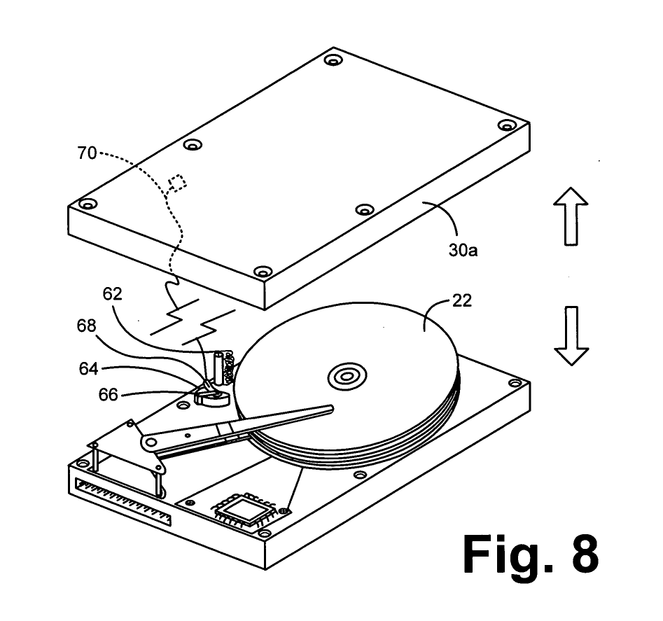

Referring now to FIG. 8 which illustrates another embodiment of active physical protection of the content of the mass storage apparatus (10). In this embodiment, a high temperature heat source is formed by a high resistance wire (62) and a battery (64). A first end of the wire (62) is connected to a battery contact for the negative terminal of the battery (64). A second end of the wire (62) is connected to a battery contact (66) for the positive terminal of the battery (64). The circuit is kept open by a battery tab (68) which is disposed between the positive terminal of the battery (64) and the battery contact (66). The battery tab (68) is connected to the sealed housing cover (30a) via the battery tab line (70) such that upon removal of the sealed housing cover (30a), the battery tab (68) is removed allowing the battery contact (66) to come into contact with the positive terminal of the battery (64) thereby closing the circuit. With the circuit closed, electric energy flows from the battery (64) and through the high resistance wire (62). The resistance of the high resistance wire (62) causes a very extreme temperature to be generated which destroys information residing on the media member (22).

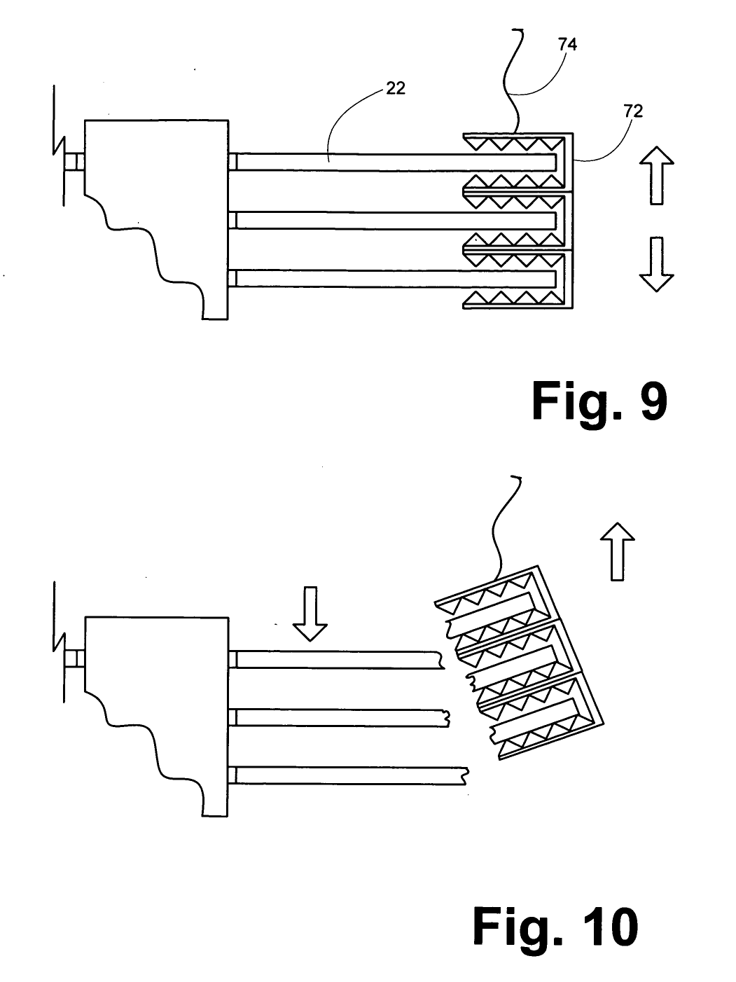

Referring to FIGS. 9 and 10 which illustrate another embodiment of active physical protection of the content of the mass storage apparatus (10). In this embodiment, teeth (72) are interspersed among and around the media member (22). The teeth (72) are secured to the sealed housing cover (30a) by a cable or other structure (74). When the sealed housing cover (30a) is removed, the teeth (72) impact and break the media member (22) as illustrated in FIG. 10.

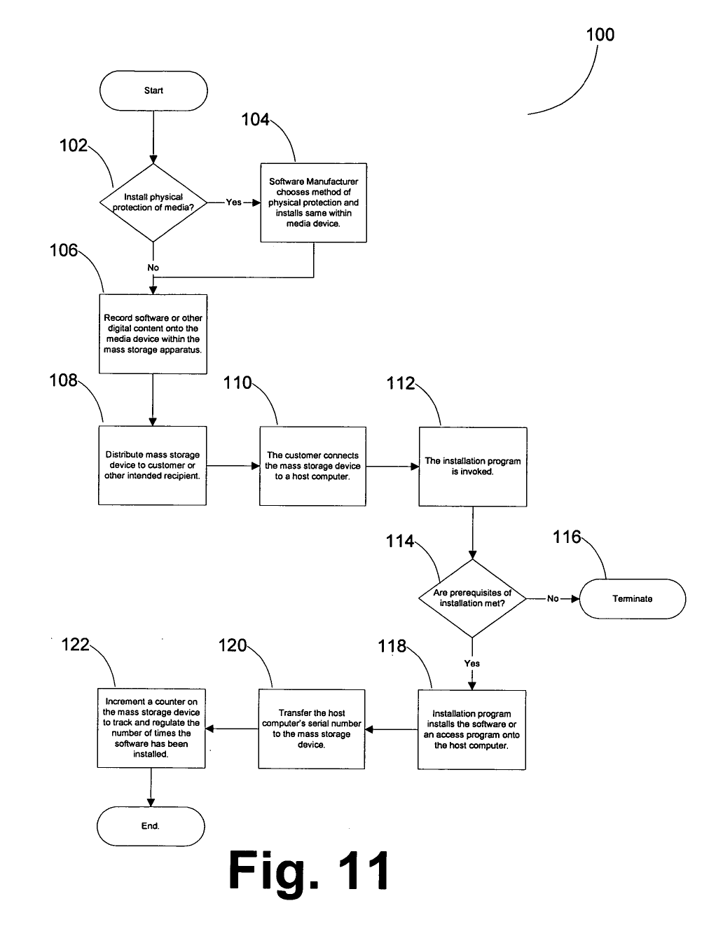

Referring now to FIG. 11 which depicts an embodiment of a method of the present invention for securely delivering digital content to a host computer (100). As depicted in FIG. 11, a software manufacturer determines whether software or other digital content stored on the mass storage apparatus warrants enhanced physical protection (102). If the software manufacturer determines that enhanced physical protection is warranted, the method of physical protection is determined and installed within the mass storage device (104). Physical protection as used in Applicants' invention refers to a physical device or apparatus installed within the mass storage device which renders the media member of the mass storage device unreadable if an unauthorized person attempts to directly access said media member by compromising the physical integrity of the mass storage device. The physical protection may consist of a corrosive liquid contained within a vessel which is distributed over the media member, a magnetic field applied to the media member by a permanent magnet or electromagnet, or physical destruction of the media member by heat, pressure, or impact.

Once the method of physical protection is selected and installed, the software or other digital content to be distributed is recorded onto the mass storage device (106). The software or other digital content may be recorded onto the mass storage device in unencrypted format or maybe encrypted prior to being recorded or as it is being recorded as a further method of protection.

The mass storage device is then distributed to the customer or other intended recipient (108) who connects the mass storage device to a host computer (110). The connection of the mass storage device to the host computer may be via a hardwired connection or via a wireless connection. Hardwired communication between the mass storage device and the host computer may be effected via serial, parallel, USB, FireWire, SCSI, IDE, or any other protocol capable of communicating between a host computer and an attached peripheral. Wireless communication between the mass storage device and the host computer may be effected via Blue Tooth, infrared, or any other wireless protocol capable of communication between a host computer and an attached peripheral.

Upon connection of the mass storage apparatus to the host computer, the installation program is invoked (112). In the preferred embodiment, the installation program will reside on the mass storage device and will be automatically invoked by the host computer's operating system upon connection of the mass storage device to the host computer. In another embodiment, the installation program may still reside on the mass storage device but require the user/customer to invoke the installation program. In yet another embodiment, the installation program will reside on media separate from the mass storage device and will require the user to run the installation program, manually or automatically, from said separate media.

Upon invocation, the installation program verifies, as a prerequisite of installation, that the user/customer has not exceeded the maximum number of installations permitted under the license agreement and that other prerequisites of installation are met (114). The maximum number of installations is determinable by the software manufacturer and may range from one to infinity. If the user/customer has exceeded the maximum number of permitted installations or some other prerequisite of installation is not met, the installation program terminates (116). Another potential prerequisite of installation is that, if the software or other digital content has already been installed at least one time, that any further installations be made to the same or a fixed maximum number of host computers. If the installation program determines that the software or other digital content had been previously installed and the software manufacturer has set an upper limit on the number of host computers onto which the software or other digital content may be installed, and that upper limit has already been reached, the installation program terminates (116).

If all of the prerequisites of installation are met, the installation program either installs the software or other digital content stored on the mass storage device onto the host computer or it installs a program designed to view the digital content stored on the mass storage device while leaving the digital content on the mass storage device (118). Where appropriate, the installation program will not copy the digital content recorded on the mass storage device onto the host computer. In those situations, a program designed to access the mass storage device and view or display the recorded digital content is installed onto the host computer.

In one embodiment of the Applicants' invention, the installation program will install the software recorded on the mass storage device to a masked location on the host computer. This measure is designed to prevent the unauthorized copying and distribution of the installed software by hiding or obfuscating the location of the installed program. The masking of the installation location is accomplished through the use of generic or randomly created directory and file names such that the nature of the installed program is not derivable simply by reviewing the contents of the directory. The masked location is typically determined by an algorithm and may be determined by any combination of time of day, date, the physical contents of the user's computer (e.g., video adapter, network card, etc.), the software already installed on the user's computer, the peripherals attached to the user's computer and any other information ascertainable at the time of installation that would aid in the creation of a random directory name.

Once the installation of the software, other digital content, or viewer for said digital content has been installed on the host computer, the serial number for the host computer may be stored in a secure location on the digital storage apparatus (120). The stored host computer serial number is used during subsequent installations to regulate the maximum number of computers onto which the software or other digital content is installed. The installation program then increments the counter stored on the mass storage apparatus which records the number of times the software, other digital content, or viewer for said digital content has been installed (122). This stored counter is used during subsequent installations to regulate the maximum number of times the software or other digital content is installed onto a host computer.

In conclusion, a mass storage apparatus is presented for securely delivering digital content to a host computer that satisfies the need to reliably, securely, and safely distribute digital content that is easy for end-users to use and for manufacturers to implement yet provides surpassing protection of Manufacturers' intellectual property. The invention is illustrated by example in the drawing figures, and throughout the written description. Although the invention has been described with reference to specific embodiments, this description is not meant to be construed in a limited sense. Various modifications of the disclosed embodiments, as well as alternative embodiments of the inventions will become apparent to persons skilled in the art upon the reference to the description of the invention. It is, therefore, contemplated that the appended claims will cover such modifications that fall within the scope of the invention.

1. A mass storage apparatus for securely delivering digital content to a host computer, the mass storage apparatus comprising:
a media member;
a sealed housing, comprising a cover member and a base member, enclosing said media member, said housing adapted to prevent physical access to said enclosed media member and to render at least some part of said media member unreadable when an attempt is made to breach said housing;
a case enclosing said sealed housing;
a two-way communications means for providing two-way communication between said mass storage apparatus and said host computer; and
a software driver, installable and executable on said host computer, adapted to facilitate electronic communication between said mass storage apparatus and said host computer via said two-way communications means while simultaneously preventing unauthorized electronic access to said digital content.

2. The mass storage apparatus of claim 1 wherein said media member is a magnetic disk.

3. The mass storage apparatus of claim 1 wherein said media member is a non-volatile, solid-state storage device.

4. The mass storage apparatus of claim 1 where said media member is an optical disk.

5. The mass storage apparatus of claim 1 wherein said two-way communications means is a universal serial bus device (USB).

6. The mass storage apparatus of claim 1 wherein said two-way communications means is a FireWire device (IEEE 1394).

7. The mass storage apparatus of claim 1 wherein said two-way communications means is an infrared device (IrDA).

8. The mass storage apparatus of claim 1 wherein said two-way communications means is comprised of a Bluetooth wireless device.

9. The mass storage apparatus of claim 1 further comprising a corrosive liquid within a vessel, said vessel positioned adjacent to said media member, and further comprising a means to breach said vessel and deposit said corrosive liquid upon said media member.

10. The mass storage apparatus of claim 1 further comprising:
a spring-loaded arm with a magnetic member at the distal end thereof, said spring-loaded arm positioned such that said magnetic member will pass over said media member when said spring-loaded arm is released;
a locking mechanism to secure said spring-loaded arm;
a releasing mechanism to release said spring-loaded arm when said sealed housing is breached.

11. The mass storage apparatus of claim 1 further comprising:
a battery;
a first conducting wire in electronic communication with the positive pole of said battery;
a second conducting wire in electronic communication with the negative pole of said battery; and
a means to bring said first and second wires in contact with said media when said sealed housing is breached thereby allowing an electric current to pass through said media member rendering at least some part of said media member unreadable.

12. The mass storage apparatus of claim 1 wherein said housing cover member and said housing base member are sealed with a fastener selected from a group consisting of one-way screws, rivets, spot welds, and epoxy.

13. A method for securely delivering digital content to a host computer using a secure mass storage apparatus, the method comprising the steps of:
embedding within said mass storage apparatus a means to permanently render portions of the media member unreadable if the physical integrity of said mass storage apparatus is breached;
storing said software or other digital content on said secure mass storage apparatus, said software or other digital content being stored on said secure mass storage apparatus in encrypted format;
providing said secure mass storage apparatus and an installation program to a user;
connecting said secure mass storage apparatus electronically to said user's computer allowing two-way communications means between said secure mass storage apparatus and said user's computer;
running said installation program;
installing said software or other digital content onto said user's computer; and
transferring the serial number of said user's personal computer onto said secure mass storage apparatus to bind said mass storage apparatus to said user's computer.

14. The method of claim 12 wherein said means to permanently disable said media member is selected from a group consisting of corrosive liquid contained within a vessel, electrical discharge, magnetic field applied by a permanent magnet, magnetic field applied by an electromagnet, or physical destruction of said media member.

15. The method of claim 12 wherein said installation program resides on said secure mass storage apparatus; said installation program being automatically invoked when said secure mass storage apparatus is connected to said user's computer.

16. The method of claim 12 wherein said installation program resides on media separate from said secure mass storage apparatus.

17. The method of claim 12 wherein said installation program installs said software or other digital content to a masked location on the mass storage device of said user's computer, said masked location being determined by an algorithm and may be determined by any combination of time, date, the physical contents of said user's computer, and the peripherals attached to said user's computer.

18. The method of claim 12 further comprising the steps of installing an access program on said user's computer for displaying said digital content, said digital content remaining on said secure mass storage apparatus and not copied to said user's computer.

19. The method of claim 17 wherein said access program is operative to disable internet or network connectivity to or from said user's computer while said digital content is being accessed.

20. The method of claim 12 wherein said installation program increments a counter stored on said secure mass storage apparatus subsequent to each successful installation of said software or other digital content and limits the number of permitted installations to a manufacturer-selected maximum number of installations.
